(19) United States
(12) Patent Application Publication
(10) Pub. No.: US 2006/0082145 A1
(43) Pub. Date: Apr. 20, 2006

(54) Quick connector with disk retention retainer

(75) Inventor: Kip R. Steveley, Rochester Hills, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: ITT Manufacturing Enterprises, Inc., Wilmington, DE (US)

(21) Appl. No.: 10/966,868

(22) Filed: Oct. 15, 2004

(51) Int. Cl. F16L 37/00

(52) U.S. Cl. 285/305

(57) ABSTRACT

A fluid quick connector for joining first and second members has a housing with a through bore extending from a first end. A retainer is movable through the bore in the housing. A lock element is carried in the housing and moved by a projection on the retainer from a first position allowing passage of a tubular member therethrough into the housing to an angled, second position with respect to the tubular member in which one or more surfaces of the lock element engage and lock the tubular member in the housing resisting axial separation of the tubular member from the housing. The lock element may be a planar disk having a central aperture.

### BACKGROUND

The present invention relates, in general, to fluid quick connectors which couple two fluid carrying components.

Snap-fit or quick connectors are employed in a wide range of applications, particularly, for joining fluid carrying conduits in automotive and industrial applications. Such quick connectors utilize retainers or lock elements for securing a tubular connector component, such as a conduit or endform, within a complimentary bore of another connector component or housing. Such retainers are typically of either the axially-displaceable or radially-displaceable type. The terms “axially-displaceable” or “radially-displaceable” are taken relative to the axial bore through the second component housing.

In a typical quick connector with an axially displaceable, retainer, the retainer is mounted within a bore in a housing of one connector component. The retainer has a plurality of radially and angularly extending legs which extend inwardly toward the axial center line of the bore in the housing. The tubular first component to be sealingly mounted in the bore in the second component includes a radially upset portion or flange which abuts an inner peripheral surface of the retainer legs. Seal and spacer members as well as a bearing or top hat are typically mounted in the bore ahead of the retainer to form a seal between the housing and the tubular conduit or endform when the endform is lockingly engaged with the retainer legs in the housing.

Radially displaceable retainers are also known in which the retainer is radially displaceable through aligned bores or apertures formed transversely to the main through bore in the housing. Examples of radially displaceable retainers are shown in U.S. Pat. Nos. 5,542,716, 5,730,481, 5,782,502, 5,863,077 and 5,951,063. The radially displaceable retainer is typically provided with a pair of depending legs which are sized and positioned to slip behind the radially upset portion or flange on the conduit only when the connector or conduit is fully seated in the bore in the housing. This ensures a positive locking engagement of the conduit with the housing as well as providing an indication that the conduit is fully seated since the radially displaceable retainer can be fully inserted into the housing only when the conduit has been fully inserted into the bore in the housing.

Regardless of the type of retainer, the housing component portion of a fluid connector typically includes an elongated stem having one or more annular barbs spaced from a first end. The barbs provide secure engagement with a hose or conduit which is forced over the barbs to connect the housing with one end of the conduit.

However, the above described fluid quick connects with either the axially displaceable or transversely displaceable retainers, make use of end endforms having an enlarged, annular bead or flange which are engaged by the retainer to lock the endform in the connector housing.

There are a large number of other fluid conduit applications which make use of smooth or constant diameter tubes without any annular flange or bead. Connectors for such cylindrical tubes typically make use of a metal washer having a plurality of flexible, radially extending grip fingers which contact the surface of the tube to create resistence to prevent pull-out or removal of the tube from the housing. However, this requires a significant insert force to urge the tube through the grip fingers which typically have a center opening smaller than the outer diameter of the tube and creates the potential for surface damage to the tube as the edges of the grip fingers scrape along the exterior surface of the tube during tube insertion.

Locking elements for smooth or constant diameter tubes are also in the form of a planar disk having an inner diameter opening slightly larger than the outer diameter of the tube. For locking purposes, the disk is pivoted to a non-perpendicular position with respect to the tube such that inner edges of the aperture in the disk forcibly engage and lock the tube in a fixed position in a surrounding housing.

However, it would be desirable to provide a fluid quick connect or for smooth, cylindrical conduits or endforms which has reduced insertion force as well as low potential for surface damage due to scraping of the exterior surface of the tube by the lock elements of the quick connect. It would also be desirable to provide a fluid quick connector for cylindrical tubular members which has increased locking capability or force upon increased removal force. At the same time, it would be desirable to provide a fluid quick connector for cylindrical tubular members which enables separation of the tube from the housing with a minimal pull-out force after disengagement of a locking mechanism from the tubular member.

### SUMMARY

A fluid quick connector has a disk retention retainer usable with smooth or constant diameter fluid carrying conduits or endforms.

In one aspect, the present fluid quick connector includes a housing having a through bore extending between first and second ends. A transverse bore is formed in the housing in communication with the through bore. A lock member is carried in the housing and has an aperture for receiving a first tubular member therethrough. A retainer is movable through the transverse bore in the housing. A lock engagement means or projection carried on the retainer engages and moves the lock member into an angular position in locked engagement with the first tubular member resisting axial separation of the first tubular member from the housing when the retainer is moved through the transverse bore in the housing to a latched position on the housing. The second end of the housing is adapted to be coupled to a second tubular member.

A method of fluidically coupling a first member to a second member is disclosed. The method includes the steps of:
providing a housing having a through bore extending between first and second ends;
disposing a lock member in the housing, the lock member having an aperture for receiving a first member therethrough;
coupling a retainer to the housing, the retainer movable relative to the housing to a latched position with respect to the housing; and
concurrent with movement of the retainer to the latched position, engaging a lock engagement means on the retainer with the lock member and pivoting the lock member to a non-perpendicular position with respect to a longitudinal axis through the first member to cause portions of the lock member to forcibly engage the first member and resist axial separation of the first member from the housing.

The above-described fluid quick connect is advantageously used with smooth or constant diameter fluid conduits. The quick connector uses a locking element having an inner diameter bore larger than the outer diameter of the tubular member which extends therethrough so as to prevent scraping and damage to the exterior surface of the tubular member during insertion of the tubular member into the connector housing and through the locking element. The present quick connector uniquely utilizes a retainer which is transversely movable through the connector housing to a latched position. Simultaneous with such movement to the latched position, a projection on the retainer engages, pivots and holds the locking element in a non-perpendicular position with respect to the tubular member causing an inner edge portion of the locking element to forcibly engage the tubular member.

The present quick connector presents reduced or minimal insertion force loads while, at the same time, is capable of generating high pull-out force resistance to maintain the tubular member in the quick connector housing. At the same time, the movement of the locking element to the locked position occurs simultaneously with movement of the retainer to the latched position thereby simplifying use of the present quick connector. The lock projection on the retainer exerts a constant locking force on the lock member. Any pullout forces exerted on the tubular member increases the lock force to resist separation of the tubular member from the housing.

### BRIEF DESCRIPTION OF THE DRAWING

The various features, advantages and other uses of the present invention will become more apparent by referring to the following detailed description and drawing in which:

FIG. 1 is a partially exploded, plan view of one aspect of a quick connector according to the present invention;

FIG. 2 is a partially exploded, cross-sectional view of the quick connector shown in FIG. 1;

FIG. 3 is an end elevational view of the quick connector depicted in a storage position;

FIG. 4 is an end elevational view of the quick connector shown in FIG. 2 depicted in a latched position;

FIGS. 5 and 6 are sequential, partial side elevational views showing the interaction of the retainer and the locking element with the tube component;

FIG. 7 is a perspective view of the retainer with the lock projection shown in FIGS. 1-6;

FIG. 8 is a perspective view of a retainer having another aspect of a lock projection;

FIG. 9 is a perspective view of a retainer having another aspect of a lock projection;

FIG. 10 is a perspective view of a retainer having another aspect of a lock projection; and

FIG. 11 is a perspective view of a retainer having another aspect of a lock projection.

### DETAILED DESCRIPTION

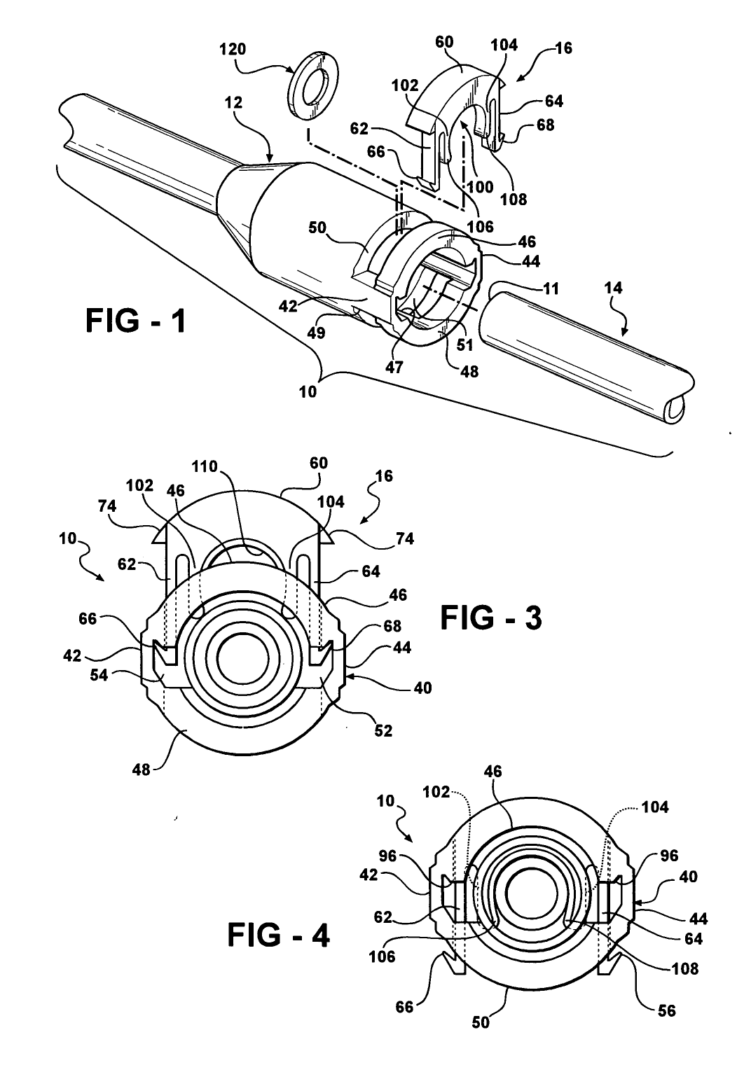

Referring to FIGS. 1-6 of the drawing, there is depicted a fluid quick connector 10 suitable for interconnecting two fluid operative or fluid carrying elements, such as conduits, tubes, as well as endforms carried on fluid operative or carrying devices, such as pumps, fuel filters, valves, valve manifolds, etc.

The quick connector 10, in the following example, will be incorporated in a first component 12 and a second component 14 which are sealingly joinable and held in a sealed, locked position by a retainer means 16. Each of the first and second components 12 and 14, as described above, may be formed as the end portion or endform of a fluid operative device, such as a conduit, pump, fuel filter, etc., or as separate elements each of which receives and is fluidically coupled to a fluid operative device, such as a conduit, by means of conduit retention barbs, spin welds, etc.

The particular shape of the endform of the first and second components 12 and 14 can be integrally formed on the end of an elongated metal or plastic tube or on a stem extending outward from a fluid use device.

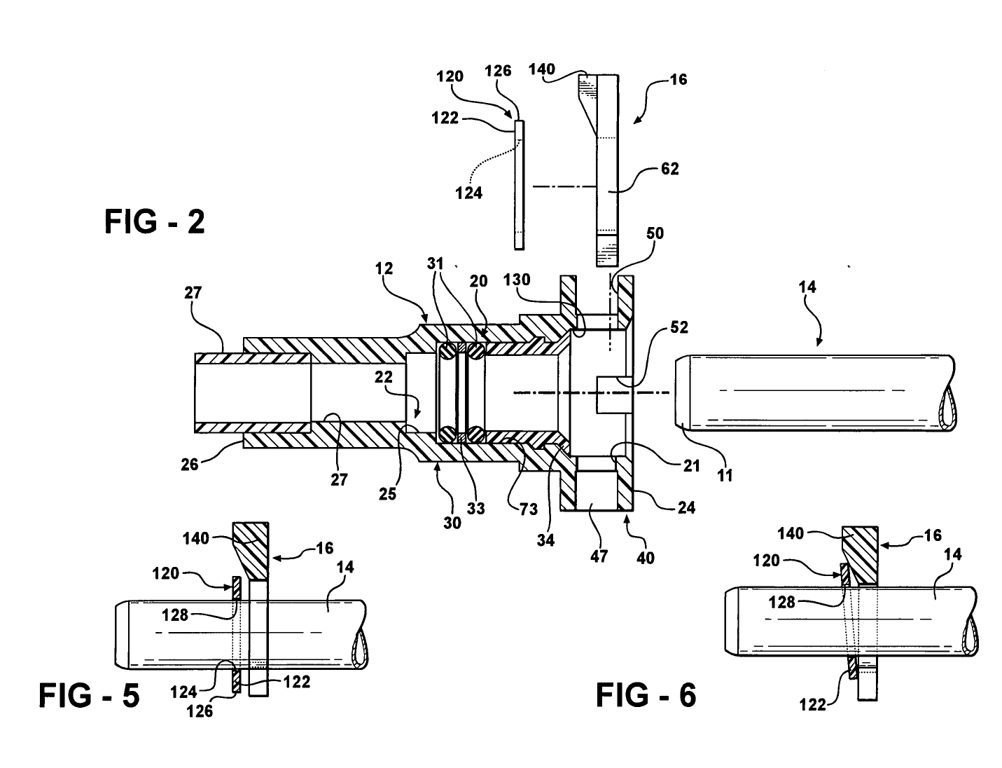

The first component 12 includes a housing 20 having an elongated, axially extending, internal stepped bore 22, shown in detail in FIG. 2, extending from a large diameter first, open end 24 to a smaller diameter, second open end 26.

Although the first component 12 may have external barbs for receiving the end of a flexible, expandable conduit thereover, by way of example only, an external conduit 27 is sealingly attached to the second end 26 of the housing 12 by spin welding. This is effected by forming the second end 26 of the housing 12 and the inner diameter of the tube with complimentary, inner and outer surfaces, respectively, which, when one of the conduit 27 or the housing 20 is rotated at high speed relative to the other which is held in a fixed, non-rotatable position, generates frictional forces and heat to create a spin weld between the mating surfaces to sealingly and securely attach the conduit 27 to the housing 12.

As shown in FIG. 2, the second end 26 of the housing 20 may have an internal step sized to receive the outer diameter end of a separate tubular member or endform. Alternately, the end of the external endform may have a stepped internal surface to fit over the second end 26 of the housing 20.

The stepped bore 22 includes a first bore portion 21 extending from an opening at the first end 24 of the housing 20 to a second smaller diameter second stepped bore portion 23. A third yet smaller diameter stepped bore portion 25 extends axially from one end of the second stepped bore portion 23 and communicates to a still smaller fourth stepped bore portion 27 which extends to the open second end 26 of the housing 20.

A top hat or bearing 34 is mounted in the second stepped bore portion 23 immediately adjacent the end of the first bore portion 21. A seal means 30 is also mounted in the second stepped bore portion 23 between one end of the top hat 34 and the third stepped bore portion 25. The seal means 30 may include one or more 0-ring seals 31 spaced by a rigid spacer member 33.

The inner diameters of the seal members 31 and 33 and the top hat 34 are sized to sealingly engage the outer diameter of a tip end 11 of the second component 14. The third stepped bore portion 25 has an inner diameter sized to snugly engage the outer diameter of the end portion 11 of the second component 14 when the second component 14 is fully inserted into the stepped bore 22 as described hereafter shown in FIG. 2.

As shown in FIGS. 1-4, the housing 20 has an enlarged end portion adjacent the first end 24. The end portion of the housing 20 denoted by reference number 40 is enlarged at least in the lateral direction from the outer diameter of the housing 20 surrounding the second bore portion 23. The enlarged end portion 40 is defined by first and second opposed, longer length, major sides 42 and 44 and opposed, intermediate sides 46 and 48. As shown in FIGS. 1, 3 and 4, the intermediate sides 42 and 44 may project laterally outward from the outer diameter of the adjacent portion of the housing 20.

A transverse aperture, generally in the form of a slot 50, is formed in the enlarged end portion 40 and extends inward from the side 42 into the first open end 24 of the housing 20. The slot 50 may extend completely through the sides 46 and 48.

A web 47 extends from one end of the enlarged end portion 42, a space portion of the housing 20. The web 47 divides the opening formed in the side edge 48 into a pair of circumferentially spaced apertures, one on each side of the web 47, between the web 47 and each of the edges 49 and 51 of the side 48. The purpose of the web 47 and the divided apertures in the side edge 48 will become more apparent hereafter.

The retainer means 16 is, by way of example only, depicted as a radially-displaceable retainer having side locking projections. The retainer 16 is preferably formed of a one-piece body of a suitable plastic, such as polyamide 12, for example. The retainer 16 has an end wall 60 which is characterized by an arcuate shape, again only by example. First and second side legs 62 and 64 project from opposite ends of the end wall 60. A hook-shaped latch projection 66 and 68 is formed adjacent the end of each of the side legs 62 and 64 for latching the retainer 16 to the housing 20 as described hereafter.

As shown in FIG. 3, a pair of axially extending notches 52 and 54 are formed in the enlarged end portion 40 of the housing 20 and extend axially inward from communication with the open first end 24 of the bore 22 substantially through the entire depth of the enlarged end portion 40. The notches 52 and 54 have a receiver end which is complimentary to the shape of the hook-like projections 66 and 68 on the side legs 62 and 64 of the retainer 16. The hook projections 66 and 68 and the notches 52 and 54 cooperate to define a temporary, storage or shipping position for the retainer 16 in the housing 20 as shown in FIG. 3. In this position, the retainer 16 is firmly attached to the housing 20 for shipping and storage prior to use. At the same time, the second component 14 may be inserted through the open first end 24 of the housing 20 into a fully inserted, sealed position in the stepped bore 22 in the housing 20 as shown in FIG. 1.

A component engaging means 100 is defined by a pair of depending arms 102 and 104 which are spaced generally in parallel and extend from the end wall 70 of the retainer 16. Each arm 102 and 104 has an enlarged end 106 and 108 which is adapted to engage the constant diameter of the end portion 11 of the second component 14 and be urged radially outward enabling the arms 102 and 104 to slide around and then snap back into registry with the opposite side of the outer diameter of the tubular end 11 of the second component 14. An inner edge 110 between the arms 102 and 104 defines a generally circular cross section having a nominal inner diameter slightly longer than the outer diameter of the tubular end 11 of the second component 14. In this manner, the arms 102 and 104 define a barrier to entry of the second component 14 into the open end 24 of the housing 20, if the retainer 16 is inserted to the fully latched position prior to full insertion of the second component 14 into the bore 22 in the housing 20.

On the other hand, if the retainer 16 is separate from the housing 20 or in the shipping position shown in FIG. 1, the second component 14 can be inserted through the open end 24 of the bore 22 in the housing 20 to the fully inserted, sealed position shown in FIG. 6. In this position, full insertion of the retainer 16 into the housing 20 will enable the hook projections 66 and 68 to slide through the slot 50 in the enlarged end portion 40 of the housing 20 and the apertures in the side edge 48 to hook around the surrounding portions of the sides 42 and 44 of the enlarged end portion 40 to lock the retainer 16 in the fully latched position.

Locking of the second component 14 in the first component or housing 12 is further enhanced by a lock means or element 120 which is in the form of a generally planar disk 122 having an inner diameter defined by an aperture 124 and an outer diameter 126. The aperture 124 can be a closed circular aperture or an aperture defined by a discontinuous edge.

As shown in FIG. 6, the outer diameter 126 of the disk 122 is larger than the outer diameter of the second component 12. At the same time, the inner diameter 124 is slightly larger than the outer diameter of the second component 12 allowing the second component 12 to be freely inserted through the aperture 124 without scraping of the exterior surface of the second component 12 by the inner edge 128 defining the aperture 124 in the disk 122.

As shown in FIGS. 1 and 2, the lock disk 122 is captured within a recess 130 in the first component 12 formed at one end of the stepped bore 21 immediately adjacent to the apertures through which the retainer element 16 moves. The lock disk 122 is held in the recess 130 by the side legs 62 and 64 and inner arms 102 and 104 of the retainer element 16 as shown in FIG. 4.

The recess 130 is slightly larger than the outer dimensions and the axial thickness of the lock disk 122. This enables the lock disk 122 to exhibit angular movement with respect to a longitudinal axis extending through the recess 130 in the first component 12 from an nominal generally perpendicular position shown in FIG. 5 when the retainer element 16 is separate from the first component or housing 12 or mounted in the first component 12 in the temporary shipping position shown in FIG. 3.

When the second component 14 is fully inserted into the bore in the first component 12 in sealing engagement with the seal rings and spacer elements 30 and the top hat 34, the retainer 16 can be urged to the fully latched position shown in FIG. 4. During this sliding movement, a preload lock tab or projection 140 carried on one end of the retainer 16 engages one end of the lock disk 122 as shown in FIGS. 2,5,6, and 7. The projection 140 applies a continuous force or load to the lock disk 122 moving and maintaining the lock disk 122 in a non-perpendicular, angular position with respect to the longitudinal axis extending through the second component 14.

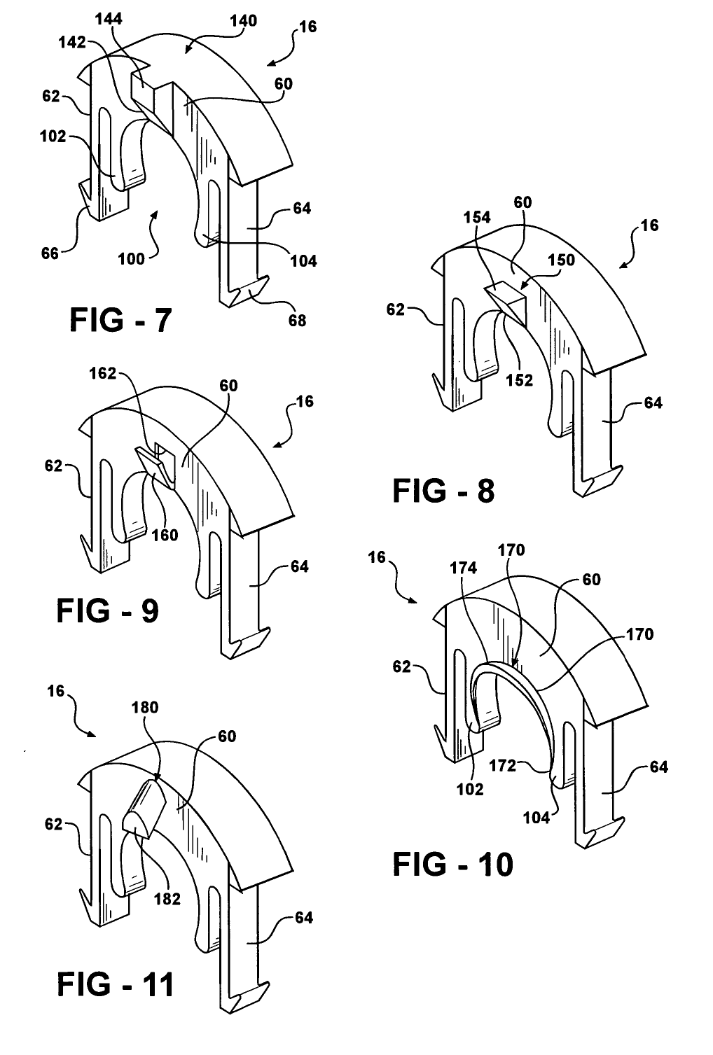

As shown in the FIGS. 2 and 5-7, the lock tab 140 is in the form of a projection extending outward from the end wall 60 of the retainer 16. The projection 140 defines a ramp surface 142 extending angularly from the inner end wall 60 between the arms 102 and 104 and a generally planar end 144 which is substantially parallel to the end wall 60 of the retainer 16. The ramp portion 142 of the projection 140 serves to force the lock disk 122 angularly from its nominal perpendicular position with respect to the longitudinal axis of the housing 12. An end portion 144 provides the constant preload side force on one edge of the lock disk 122 to maintain the lock disk 122 under a constant spring force to maintain the lock disk 122 in the angularly offset position. A measure of resiliency to the tab 140 and the disk 122 connection can be provided by forming the disk 122 with flexibility, either by material selection, thickness, or combinations thereof

Referring now to FIG. 8, there is depicted another aspect of a lock projection 150. The lock projection 150 is also carried, attached or molded as part of the end wall 60 as part of the retainer 16. The projection 150 includes a ramp portion 152, similar to the ramp portion 142 in the projection 140 described above. An end portion 154 on the projection 150 is relatively short in length, but still provides a constant spring force on the lock disk 122.

Yet another aspect of a lock projection 160 is shown in FIG. 9. In this aspect of the invention, the lock projection 160 is formed as an angularly disposed tab which extends integrally and angularly outward from an aperture 162 formed in the end wall 60 of the retainer 16. The angular disposition of the tab 160 functions similarly to the ramp surfaces 142 and 152 described above by providing a resilient spring force against the lock disk 122, due to the resilient connection of the tab 160 to the wall 60

Another aspect of a lock projection 170 is shown in FIG. 10. In this aspect, the inner circumferential periphery of the retainer 16 between the arms 102 and 104 and the central end wall 60 is formed with an enlargement or projection 170 which tapers outwardly in increased thickness from a first end 172 adjacent the radially innermost ends of each of the arms 102 and 104 to a greater thickness at a central end 174. The projection 170 functions to provide the angular offset of one end of the lock disk 122 and provides a constant spring force on the angularly disposed lock disk 122.

As the projection 170 extends over substantially the entire inner edge of the arms 102 and 104 and the adjoining end wall 60, the projection 170 provides a constant preload force on the lock disk 122 over at least 180° or more of the surface engagement between the lock disk 122 and the projection 170.

In FIG. 11, a projection of 180 is carried, mounted or otherwise attached to the end wall 50 of the retainer 16. The projection 180 in the form of a generally semicircular shaped member having an end wall 182 disposed angularly from the plane of the central end wall 60. The end wall 182 is formed on one end of the projection 180 and provides the angular offset of one end of the lock disk 122.

This non-angular position, shown in FIG. 6, causes a portion of the inner diameter edge 128 of the lock disk 122 to forcibly engage the exterior surface of the second component 14. A diametrically opposed portion 128′ of the inner diameter 124 of the lock disk 122 to also forcibly engage a diametrically opposed portion of the exterior surface of the second component 14. This forced engagement under constant load exerted of the projection 140 on the lock disk 122 forcibly locks the second component 14 in the first component 12 preventing pull-out up to a predetermined load.

As shown in FIG. 6, the ring portion of the lock disk 122 opposite from the diametrically opposed ring portion in contact with locking projection 140 angularly moves in between the legs 62 and 64 of the retainer 16 to allow a maximum amount of angular disposition of the lock disk of 122. This applies the greatest amount of locking force on the second component 14 and provides a high pullout force resistance to any separation of the component 14 in the housing 12.

When it is necessary to separate the second component 14 from the first component 12, the retainer 16 is disengaged from the first component 12 by radially inward force exerted on the hook ends of the legs 62 and 64 of the retainer 16 while at the same time exerting a sliding force to move the retainer 16 relative to the first component 12 back to at least the shipping position shown in FIG. 3 or completely from the first component 12. Once the lock projection 140, or any of the other projections described above, separates from the lock disk 122, the lock disk 122 is able to return to a perpendicular position relative to the longitudinal axis of the second component 14 allowing the second component 14 to slide freely through the central aperture 124 in the lock disk 122 until the second component 14 is separated from the housing or first component 12.

In summary, the disclosed fluid connector for cylindrical conduits or endforms forcibly locks a cylindrical conduit or endform in a connector housing with minimal insertion forces, minimal potential for scraping and damaging the exterior surface of the tube during insertion and removal from the connector housing and at the same time, provides high pull-out forces sufficient to retain the tube or endform in the connector housing.

What is claimed is:

1. A fluid connector for fluidically coupling a first tubular member to a second member comprising:
a housing having a through bore extending between first and second ends;
a lock member carried on the housing, the lock member having an aperture receiving the first tubular member therethrough;
a retainer movable through the bore in the housing; and
lock engagement means, carried on the retainer, for engaging and moving the lock member into locked engagement with the first tubular member resisting axially separation of the first tubular member from the housing when the retainer is moved into the bore in the housing.

2. The fluid connector of claim 1 wherein:
the lock engagement means exerts a constant lock force on the lock member;

3. The fluid connector of claim 1 wherein the lock engagement means moves the lock member to a non-ninety degree angular position with respect to a longitudinal axis of the first tubular member bringing portions of an inner diameter of the lock member into engagement with the first tubular member.

4. The fluid connector of claim 1 wherein the lock engagement means retains the lock member in locked engagement with the first tubular member when the retainer is latched to the housing.

5. The fluid connector of claim 1 wherein the lock member comprises:
a planar disk having the aperture extending therethrough.

6. The fluid connector of claim 5 wherein:
the planar disk has an inner edge at the aperture, at least one portion of the inner edge engaging the first tubular member when the lock member is moved into lock engagement with the first tubular member.

7. The fluid quick connector of claim 6 wherein:
the aperture in the disk is closed aperture; and
opposed portions of the inner edge of the disk engage the first tubular member when the disk is moved into locked engagement with the first tubular member.

8. The fluid connector of claim 1 further comprising:
a transverse bore in the housing communicating with the through bore; and
the retainer movable through the transverse bore in the housing.

9. The fluid connector of claim 8 wherein the retainer comprises:
a body having an end wall and two outwardly projecting, opposed side legs; and
housing engagement surfaces formed on the side legs for latching the retainer to the housing.

10. The fluid connector of claim 9 further comprising:
axially extending recesses formed in the housing extending from the first end of the housing; and
the recesses receiving the engagement members on the side legs of the retainer to latch the retainer in a partially inserted, storage position in the housing adapted for receiving a first member therethrough.

11. The fluid connector of claim I further comprising:
the second member sealingly joined to the second end of the housing.

12. The fluid connector of claim 11 wherein:
the second member is spun welded to the housing.

13. The fluid connector of claim 1 wherein the lock engagement means comprises:
a lock projection extending from the retainer, an angular ramp surface carried on the lock projection.

14. The fluid quick connector of claim 13 wherein:
the ramp surface increases in angle in a direction perpendicular to a longitudinal axis through the housing.

15. The fluid quick connector of claim 1 wherein the lock engagement means comprises:
a lock tab resiliently angularly extending from the retainer.

16. The fluid quick connector of claim 15 wherein:
the tab has first and second opposed ends, the first end unitary with the retainer, the second end spaced from the retainer.

17. The fluid quick connector of claim 1 further comprising:
the retainer including an end wall and a pair of inner arms depending from the end wall for engagement with the first tubular member.

18. The fluid quick connector of claim 17 wherein:
the engagement means extending angularly from the end wall.

19. The fluid quick connector of claim 18 wherein:
a tapered surface extending between the pair of inner arms and the end wall, the tapered surface increasing in angle from one end adjacent the pair of inner arms to an opposite end adjacent to the end wall of the retainer.

20. The fluid quick connector of claim 1 wherein the lock engagement means comprises:
a resilient lock engagement member extending angularly from the retainer.

21. The fluid quick connector of claim 20 wherein:
the resilient lock engagement member has a first end joined to the retainer and a second end angularly spaced from the retainer.

22. A method of fluidly coupling a first member to a second member, the method comprising the steps of:
providing a housing having a through bore extending between first and second ends;
disposing a lock member in the housing, the lock member having an aperture for receiving a first member therethrough;
coupling a retainer to the housing, the retainer movable relative to the housing to a latched position in the housing; and
concurrent with movement of the retainer to the latched position, and engagement of the retainer with the lock member, pivoting the lock member to a non-perpendicular position with respect to a longitudinal axis through the housing to cause at least one portion of the lock member to forcibly engage the first member and resist axial separation of the first member from the housing.

23. The method of claim 22 further comprising the step of:
forming engagement surfaces in a through bore in a lock member, the engagement surfaces engaging the first member when the lock member is pivoted to the non-perpendicular position.

24. The method of claim 23 further comprising the step of:
mounting a lock engagement means on the retainer and forming a lock member engagement surface on the lock engagement means to angularly move the lock member to an angular position with respect to the longitudinal axis concurrent with insertion of the retainer into the housing.

25. The method of claim 24 wherein the step of forming a lock member engagement surface further comprises:
forming the lock engagement means as a resilient lock engagement means so that the lock engagement means exerts a constant spring force on the lock member.
